(19) United States
(12) Patent Application Publication
(10) Pub. No.: US 2004/0230690 A1
(43) Pub. Date: Nov. 18, 2004

(54) Protocol for data hosting servers

(76) Inventor: Jin Teik Teh, Los Altos, CA (US)

Correspondence Address: Jason Z LIN, Supreme Patent Services, Post Office Box 2339, Saratoga, CA, 95070-0339, US

(21) Appl. No.: 10/440,383

(22) Filed: May 17, 2003

(51) Int. Cl. G06F 15/16

(52) U.S. Cl. 709/230

(57) ABSTRACT

The present invention discloses a protocol and data formats for a data hosting server used in a data access system. The data hosting server of the present invention is designed as an application server that hosts only personal information of the users, but not the public contents that need to be purchased by the user. As all requests from the users to read from or write to the personal information must be made through the data hosting server, the other application servers of the system can focus on serving the paid functions for application subscribers. As the data hosting server handles various data types, it must understand the format to be hosted, including file-based formats and record-based formats, etc. Furthermore, the data hosting server must also be able to load additional data format modules dynamically as data of new types are hosted. It must also be able to remove data format modules that are no longer provided.

### FIELD OF THE INVENTION

This invention relates to a data format and protocol for a hosting server that manages personal information in a data access system, and more specially to a data format and protocol that allows the hosting server to store all types of data without knowing the exact format of data.

### BACKGROUND OF THE INVENTION

Due to the rapid progress in the wired and wireless communication, more and more data access systems are developed in order to provide users of mobile devices the access to a wide range and large amount of applications and data. These systems aim to provide users with a seamless and easy access to various applications and data on a subscription basis. However, when number of users accessing to the system is large, the performance would become inhibitively slow. A possible solution for this problem is a mechanism that would alleviate certain data access loadings from the data access system.

A data hosting server is an application server for this purpose. It should provide hosting services for information such as text message, picture messages, emails, phonebook records, uploaded image and audio files, stock portfolios and subscription information. It is necessary for the hosting server to have a method for describing various types of data used for personal data. For example, data can be put into two types of categories—record based, or streamed (or file) based. Examples of file-based format are photos, audio and multi-media files, and examples of record-based formats are phonebook records, calendar records and messaging records. Record based data consists of fields of individual data that can be searched and sorted. The order of the fields in the record is not important and does not affect the information stored in the record. File (or stream) based data is usually a binary file where data have to be in a certain order and data in the file cannot be sorted or easily searched. In most systems, an application only knows one type or category of data, and when the data format changes, the application has to be rewritten. This invention makes it easy to change the data format without needing to change the application to read or write it.

### SUMMARY OF THE INVENTION

The present invention comprises data formats and a protocol for a data hosting server used in a data access system. The data hosting server of the present invention is designed as an application server that hosts only personal information of the users, but not the public contents that need to be purchased by the user. There is a purpose for this separation of data. As all requests from the users to read from or write to the personal information must be made through the data hosting server, the other application servers of the system can focus on serving the paid functions for application subscribers.

The main purpose of this invention is to provide a generic way of storing various types of data, and hence being able to store all types of data without knowing the exact format of each data. This feature provides another advantage that it is easy to change the data format without needing to change the application to read or write it. Thus, the present invention proposes a method for describing various types of data used for personal data. For example, data can be put into two types of categories—record based, or streamed (or file) based. There is also an important performance criterion that such a data hosting server must meet. As the major storage requirement is in the data store, a scalable implementation is usually preferable so that it can deliver acceptable performance under high load. Furthermore, the data hosting server must also be able to load additional data format modules dynamically as data of new types are hosted. It must also be able to remove data format modules that are no longer provided.

The present invention will become more obvious from the following description when taken in connection with the accompanying drawings, which shows for purpose of illustration only, a preferred embodiment in accordance with the present invention.

### BRIEF DESCRIPTION OF THE DRAWING

The foregoing aspects and many of the attendant advantages of this invention will become more readily appreciated as the same becomes better understood by reference to the following detailed description, when taken in conjunction with the accompanying drawings, wherein:

FIG. 1 is a pictorial representation of hosting server internal architecture;

FIG. 2 is the content of file based data format of the embodiment of the present invention;

FIG. 3 is the content of record based format of the embodiment of the present invention; and

FIG. 4 is the database design of the embodiment of the present invention.

### DETAILED DESCRIPTION OF THE INVENTION

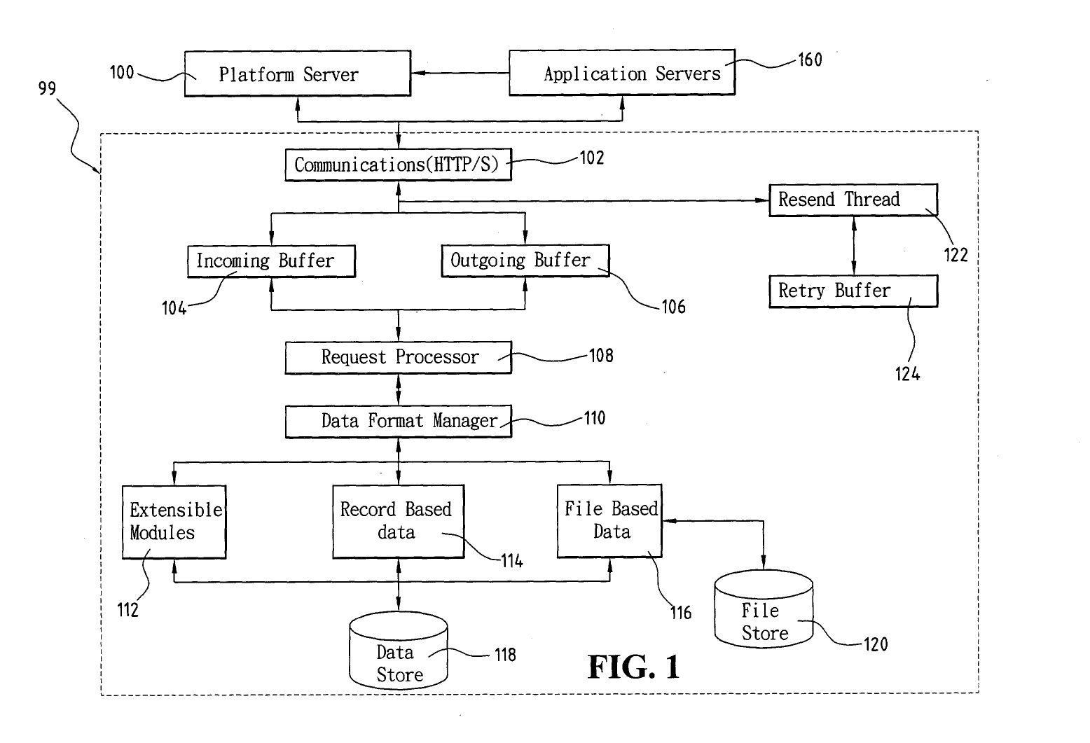

A pictorial representation of hosting server internal architecture is shown in FIG. 1, which comprises a platform server 100, a plurality of application servers 160, and a hosting server 99. The platform server 100 provides generic functionality for managing all application and data that belong to users. While the application servers 160 are servers that manage all processes and tasks specific to an application of product or service. Usually this would reside outside the customer's local area network. Application client (not shown) is a separate module or process that resides on the client that provides a specific task for the client, for example, it can be a specialized application that handles drawing of vector graphics, the playing of MP3 audio files, or a wide range of other applications. Alternatively, it can even be an application logic client that handles the input and transaction of stock trades. On the other hand, the hosting server 99 sits outside the platform server 100 because it must be accessible from the application server 160. It communicates with the platform server 100 as an application server 160 does. Furthermore, the hosting server 99 consists of a request processor 108 that handles all incoming message from the platform server 100 and application servers 160 while the application servers 160 are primarily to handle the application control logic and non-personal data. It must be noted that in this invention all read and write from and to personal data must be made through the hosting server 99. The hosting server 99 must be able to load additional data format modules dynamically. The hosting server 99 must also be able to remove data format modules that will no longer be provided. Under the circumstances, the hosting server 99 must have an ability to understand the format of the data message so that the data message can be hosted.

The data hosting server 99 as shown in FIG. 1, further comprising a communication module 102, an incoming buffer 104, an outgoing buffer 106, a request processor 108, a data format manager 110 for managing an extensible modules 112, a record-based data format 114, and a file-base data format 116, a data store 118, a file store 120 for storing file-based data, a resend thread process 122 and a retry buffer 124 used by the resend thread 124.

The communications module 102 accepts requests from the platform server 100 and application servers 160. It can also connect the platform server 100 or the application servers 160 to return the results of a request. The hosting server 99, for example, may be implemented as an application server 160 with a HTTP interface, or other communication transport protocols.

The incoming buffer 104 stores all incoming messages. The messages are received from the platform server 100 or from application servers 160. When a new message is received, the request process 108 is notified of the new message. On the other hand, the outgoing buffer 106 stores all outgoing message to be sent to the platform server 100 or the application servers 160. When a new message is received, the communications is notified so that it can be sent out.

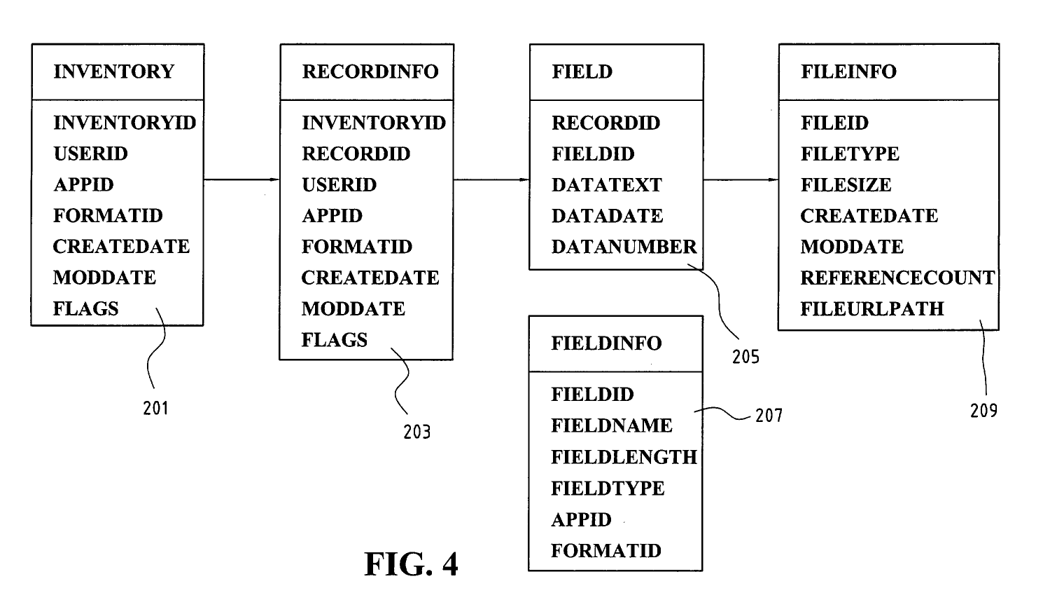

The request processor 108 handles all incoming and outgoing requests. Incoming messages from the platform server 100 are passed to the data format manager 110 for processing in accordance with their data type. The application manager 110 manages all the available data format modules in the data hosting server, such as a record-based data format 114 and a file-based data format 116, as well as an extensible module 112 that allows to the data server to add new data format module when necessary. Examples of record based formats 114 are phone book records, calendar records and messaging records, and examples of file based formats 116 are photo, audio and multimedia files. The all hosted data are stored in the data store 118, and the file store 120, which will be described in details in FIG. 4.

The retry buffer 124 stores all outgoing messages that failed to be sent to the application server 160 or platform server 100. The messages will be retried after a preset number of times. The resend thread 122 picks up messages from the retry buffer 124 at specified intervals for resending.

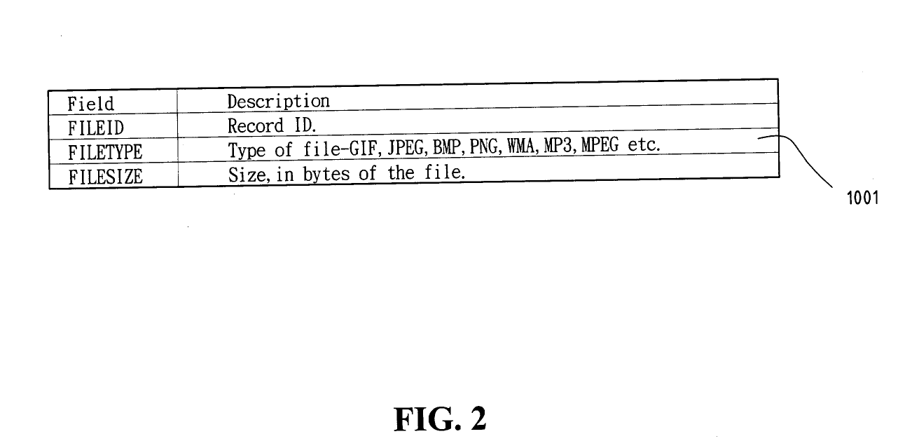

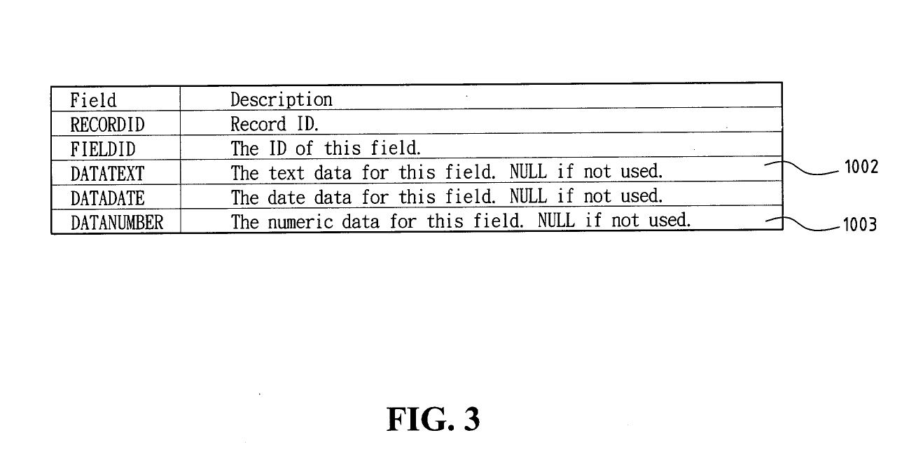

FIG. 2 and FIG. 3 show the records for the file-based data format and the record-based data format of the embodiment of the present invention, respectively. The file-based data format comprises a FileID field for storing file ID, a FileType field for indicating type of the file, such as GIF, JPEG, BMP, PNG, WMA, MP3, MPEG, and a FileSize field for indicating the size of the file in bytes. The record-based data format comprises a RecordID field for storing record ID, a FieldID for storing ID of this field, a DataText field for storing text data for this field, a DataDate field for storing date data for this field, and a DataNumber field for storing numeric data for this field.

FIG. 4 shows the database design for data store 118 and the file store 120 in FIG. 1. The database contains five tables, which are INVENTORY 201, RECORDINFO 203, FIELD 205, FIELDINFO 207, and FILEINFO 209. The INVENTORY 201 table ties multiple records together, e.g. an email inventory ties together the email template and each attachment. The RECORDINFO 203 table holds the record fields. The FIELD 205 table contains the actual data for each record field. The FILEINFO 209 table contains links to the actual physical file while the FIELDINFO 207 table contains a mapping of the field ID's, field types and field lengths for each application field. Application can retrieve INVENTORIES 201 separately or individually. The hosting server 99 will in this case return the entire tree of the INVENTORY 201 excluding the actual file data. Application can retrieve RECORDINFOs 203 separately or individually. They can also be retrieved using search criteria based on the FIELDs 205 of the record. The RECORDINFO 203 tree of the query result will be returned while the actual file data will not be returned.

By using a generic way of storing various types of data, the present invention allows data hosting server to store all types of data without knowing the exact format of each data. This feature provides another advantage. In most implementations, an application only knows a certain type or category of data. When the data format changes, the application has to be rewritten. With this invention, it is easy to change the data format without needing to change the application to read or write it.

The present invention is a protocol for storing and retrieving requested data for a client. Referring to FIG. 1, the protocol comprises the following operations:

storing requested data, which further comprising the following steps of:

(1). the platform server 10 or application server 160 sending requests,

(2). the requests being received by the communication module 102, and stored in incoming buffer 104,

(3). the request processor 108 receiving requests in incoming buffer 104, interpreting the requests, and calling data format manager 110 using a corresponding data format module to process the storing,

(4). the requested data being stored in either data store 118 or file store 120, a corresponding record is created to store the information on the requested data,

(5). a result message of the storing being generated by the data format manager 110, passed to request processor 108, placed in the outgoing buffer 106, and sent to the requesting platform server 100 or application server 160 through the communication module 102.

retrieving requested data, which further comprising the following steps of:

(1). the platform server 110 or application server 160 sending requests,

(2). the requests being received by the communication module 102, and stored in incoming buffer 104,

(3). the request processor 108 receiving requests in incoming buffer 104, interpreting the requests, and calling data format manager 110 to find the requested data in either data store 118 or file store 120, and

(4). the requested data being retrieved by the data format manager 110, passed to request processor 108, placed in the outgoing buffer 106, and sent to the requesting platform server 100 or application server 160 through the communication module 102.

resending results, which will be carried out when the sending to the platform server 100 or the application server 160 is unsuccessful. The outgoing messages will be re-directed to the retry buffer 124, from where the resend thread 122 will pick up messages at specified intervals for resending.

While the preferred embodiment of the invention has been illustrated and described, it will be appreciated that various changes can be made therein without departing from the spirit and scope of the invention.

What is claimed is:

1. In a data accessing system having a platform server, a plurality of application servers, and a data hosting server, a protocol for providing a generic way of storing various types of data on said data hosting server, said protocol comprising:
defining data formats for data to be hosted on said data hosting server;
storing data on said data hosting server as requested by said platform server or said application server;
retrieving data from said data hosting server as requested by said platform server or said application server; and
sending said requested result to said requesting platform server or said application server.

2. The protocol as claimed in claim 1, wherein said data is a file-based data.

3. The protocol as claimed in claim 1, wherein said data is a record-based data.

4. The protocol as claimed in claim 1, wherein said result will be resent when said first sending is unsuccessful.

5. In a data accessing system having a platform server, a plurality of application servers, and a data hosting server comprising a communication module, an incoming buffer, an outgoing buffer, a request processor, a data format manager managing an extensible modules, a record-based data format, and a file-base data format, a data store, a file store, a resend thread process and a retry buffer, a protocol for providing a generic way of storing various types of data on said data hosting server, said protocol comprising:
defining data formats for data to be hosted on said data hosting server;
storing data on said data hosting server as requested by said platform server or said application server; and
retrieving data from said data hosting server as requested by said platform server or said application server; and
sending said requested results to said requesting platform server or said application server.

6. The protocol as claimed in claim 5, wherein said data is a file-based data.

7. The protocol as claimed in claim 5, wherein said data is a record-based data.

8. The protocol as claimed in claim 5, wherein said storing requested data further comprising the following steps of:
said platform server or said application server sending requests,
said requests being received by said communication module, and stored in said incoming buffer,
said request processor receiving said requests in said incoming buffer, interpreting said requests, and calling said data format manager using a corresponding data format module to process the storing,
said requested data being stored in either said data store or said file store, a corresponding record is created to store the information on said requested data,
a result message of the storing being generated said data format manager, passed to said request processor, placed in said outgoing buffer, and sent to said requesting platform server or said application server through said communication module.

9. The protocol as claimed in claim 5, wherein said retrieving requested data further comprising the following steps of:
said platform server or said application server sending requests,
said requests being received by said communication module, and stored in said incoming buffer,
said request processor receiving said requests in said incoming buffer, interpreting said requests, and calling said data format manager using a corresponding data format module to find said requested data in either said data store or said file store,
said requested data being retrieved from either said data store or said file store, and
said requested data being passed to said request processor, placed in said outgoing buffer, and sent to said requesting platform server or said application server through said communication module.

10. The protocol as claimed in claim 5, wherein said results will be resent when said first sending to said platform server or said application server is unsuccessful. The outgoing messages will be re-directed to said retry buffer, from where said messages will be picked up at specified intervals for resending.

11. The protocol as claimed in claim 5, wherein said data format manger uses said extensible modules to add new data format.

12. The protocol as claimed in claim 5, wherein said data format manger uses said extensible modules to remove data format which is no longer provided.

13. An apparatus used in a data accessing system having a platform server, a plurality of application servers, and a data hosting server, said apparatus connecting to said data hosting server, said apparatus comprising:
a memory storing a program, and
a processor responsive to the program to:
(1). define data formats for data to be hosted on said data hosting server,
(2). store data on said data hosting server as requested by said platform server or said application server,
(3). retrieve data from said data hosting server as requested by said platform server or said application server.
(4). send said requested result to said requesting platform server or said application server.

14. A data hosting server comprising an apparatus, said apparatus comprising:
a memory storing a program, and
a processor responsive to the program to:
(1). define data formats for data to be hosted on said data hosting server,
(2). store data on said data hosting server as requested by a platform server or an application server,
(3). retrieve data from said data hosting server as requested by said platform server or said application server.
(4). send said requested result to said requesting platform server or said application server.

15. A data hosting server as in claim 14, wherein said memory is a harddisk.
